(19) United States
(12) Patent Application Publication
(10) Pub. No.: US 2006/0091755 A1
(43) Pub. Date: May 4, 2006

(54) Transverse flux switched reluctance motor and control methods

(75) Inventor: Brian R. Carlisle, Auburn, CA (US)

Correspondence Address: WOLF GREENFIELD & SACKS, PC;FEDERAL RESERVE PLAZA, 600 ATLANTIC AVENUE, BOSTON, MA, 02210-2206, US

(73) Assignee: Precise Automation, LLC, Auburn, CA (US)

(21) Appl. No.: 10/976,047

(22) Filed: Oct. 28, 2004

(51) Int. Cl. H02K 19/00; H02K 19/20

(52) U.S. Cl. 310/168; 318/701; 310/164

(57) ABSTRACT

A variable reluctance motor and methods for control. The motor may include N motor phases, where N equals three or more. Each motor phase may include a coil to generate a magnetic flux, a stator and a rotor. A flux-carrying element for the rotor and/or stator may be made entirely of SMC. The stators and rotors of the N motor phases may be arranged relative to each other so that when the stator and rotor teeth of a selected phase are aligned, the stator and rotor teeth in each of the other motor phases are offset from each other, e.g., by an integer multiple of 1/N of a pitch of the stator or rotor teeth. A fill factor of the coil relative to the space in which it is housed may be at least 60%, and up to 90% or more. The stator and rotor flux-carrying elements together may include at most three separable parts.

### BACKGROUND OF INVENTION

Aspects of the invention relate to variable reluctance, or switched reluctance, motors and methods for control of such motors.

Many electric drive applications require high rotary torque or linear thrust at relatively low speeds. To generate this power, a transmission or speed reducer is often interposed between a high-speed power source and the output shaft. This transmission is almost always mechanical in nature, with costly highly loaded components that are subject to wear over time. This wear results in lost precision of motion, which is undesirable and limits both the life and the capability of the power source.

As a result, there has recently been increased interest in direct-drive electric motors for both rotary and linear applications. These motors are designed to generate high torque or thrust at relatively low speeds, thereby eliminating the need for a speed reducer between the motor and the load.

Many such motors have been designed using brushless, permanent magnet, multi-pole concepts. In some cases, it is desirable to have a large number of poles to increase the torque at low speeds. However, for conventional permanent magnet motors, increasing the number of poles increases the number of windings and the number of magnets. This increases the manufacturing complexity of the motor and this practice reaches a practical upper limit due to cost and inefficiencies associated with winding the motor, when the fill factor of the copper in the motor winding slots falls to 40% or less. In addition, due to the cost of the magnets and the complexity of bonding many magnets to a motor structure, this class of motor tends to be expensive. Finally, there is a limit to the flux density that can be applied to permanent magnets without demagnetizing them. This flux density is significantly lower than the density that can be achieved by saturating iron, so this class of motor will typically generate less torque for a given amount of power than a motor in which flux density is not limited by permanent magnets.

A different class of direct-drive motors, termed variable reluctance or switched reluctance motors, overcomes many of these limitations. This class of motor does not require a winding for each tooth, and hence can have many small teeth generating high torque at low speeds. In addition, it does not use permanent magnets and therefore can be driven at higher flux densities than permanent magnet motors. This class of motors is often used for low-cost, high torque applications in the form of small stepping motors, which generally operate without speed reducers.

However, even this class of direct-drive motor is limited in efficiency by two major factors; the amount of copper in the motor winding slot is still low compared to the available space, i.e., the fill factor is typically about 40%, and the end turns of the winding coil generate no magnetic flux and hence create energy losses due to resistance in the coil.

Consequently, there have been efforts to develop switched reluctance motor topologies that allow flux to be driven through many teeth from a single coil, as well as topologies that improve the utilization of copper in the coil by eliminating end turns and increasing the percentage of coil area filled with copper.

Katzinger, (U.S. Pat. No. 6,657,329, “Unipolar Transverse Flux Machine”), discloses the idea of a series of “C” shaped laminations arranged around a hoop coil such that there are no end turn losses.

Amreiz, “Switched Reluctance Machine with Simple Hoop Windings”, IEEE Power Electronics, Machines and Drives, 2002. International Conference on (Conf. Publ. No. 487), 4-7 Jun. 2002 Pages: 522-527, discloses another hoop coil topology for a switched reluctance motor.

However both these designs utilize stamped laminations, which must be individually stamped, fastened together into a substructure, and the substructure aligned and fastened into a larger structure, resulting in a fabrication and assembly process significantly more costly than is provided by aspects of the invention.

### SUMMARY OF INVENTION

As has been appreciated by the inventor, the advent of a new material, a “soft magnetic composite” or “SMC,” has allowed the design of cost-effective new motor topologies that can eliminate end turn losses and greatly improve the density of the winding coil (the winding “fill factor”). SMC material allows the magnetic flux to efficiently travel in 3 dimensions and opens up new design possibilities. This material is available as an iron powder whose particles are coated with a thin layer of plastic so that the material is magnetically permeable, but is electrically insulating so as to prevent eddy current losses. SMC powder allows precision geometries to be created by compressing the material to form a part of a desired shape, thereby eliminating costly machining operations.

However, SMC material is not without its drawbacks. The first generation of this class of material, which was offered by several manufacturers in the mid 1990s, was extremely fragile and had relatively poor magnetic properties, greatly limiting its use. A second-generation material was introduced in the late 1990s, with substantially improved magnetic properties, and better mechanical strength after pressing. An example of such a second-generation material is “Somaloy 500” manufactured by Hoganas Corporation of Sweden. The permeability of second generation SMC materials, while improved, was still lower than in conventional motor lamination material such as, for example M19, such that motors would exhibit thermal problems in higher torque applications due to the high currents necessary to drive sufficient flux through the relatively low permeability SMC material. In addition, SMC material has higher AC core losses than commonly used motor lamination material, resulting in higher motor heating than with conventional lamination materials such as, for example M19. For example, Somaloy 500, an SMC material provided by Hoganas Corp of Sweden, has 1/10^{th} the permeability and 3 times the hysteresis loss, of M19, a commonly used motor lamination material. The hysteresis loss is typically generated every time the magnetic flux is switched on in the material and then switched off. This happens both during pulse-width modulation of the coil current, and during commutation of the motor. The losses are proportional to the level of magnetic induction and to the square of the switching frequency.

A third-generation SMC material with further improvements in permeability and AC core losses has now been developed and is undergoing laboratory testing.

To achieve the goal of producing a low cost direct-drive motor that is capable of generating high torque at low speeds for both rotary and linear motions, aspects of the invention provide a new switched reluctance motor, which when combined with control methods described later, address all of the previously described problems that exist with current motor designs. These designs incorporate SMC material in a novel way so as to maximize its benefits, while minimizing some if its drawbacks.

One aspect of the invention provides a variable reluctance motor having at least N motor phases, where N is equal to one or more, e.g., at least three. Each motor phase may include a coil adapted to carry an electrical current and generate a magnetic flux, a stator and a rotor. The stator may include a stator flux-carrying element that provides the magnetic flux paths for the stator. The stator flux-carrying element may have a plurality of stator teeth and be made entirely of SMC. The rotor may include a rotor flux-carrying element that provides the magnetic flux paths for the rotor. The rotor flux-carrying element may have a plurality of rotor teeth and be made entirely of SMC. Thus, although the stator and/or rotor may include other parts, the magnetically functioning parts of the stator and/or rotor, i.e., the flux-carrying elements, may be made entirely of SMC, thereby simplifying the manufacturing and assembly of the motor.

The stators and rotors of the N motor phases may be arranged relative to each other so that when the stator and rotor teeth of a selected phase are aligned, the stator and rotor teeth in each of the other motor phases are offset from each other. In one embodiment, the stator and rotor teeth of the other phases may be offset from each other by an integer multiple of 1/N of a pitch of the stator or rotor teeth. The integer multiple of 1/N may be a number other than 1.

In another aspect of the invention, a variable reluctance motor includes N motor phases where N may be 1 or more. Each phase may include a coil adapted to carry an electrical current and generate a magnetic flux, a stator and a rotor. The stator may include a stator flux-carrying element that provides magnetic flux paths for the stator, has a plurality of stator teeth and is magnetically permeable. The rotor may include a rotor flux-carrying element that provides magnetic flux paths for the rotor, has a plurality of rotor teeth and is magnetically permeable. The coil may be arranged in a space relative to the stator or the rotor and have a fill factor of at least 60%. For example, the coil may be formed from a flat foil that is wound to form a hoop coil that is fit into a channel formed in a stator. In one embodiment, the fill factor may be up to 90% or more, which far exceeds that found in some motor types.

In another aspect of the invention, a variable reluctance motor comprising N motor phases includes a coil adapted to carry an electrical current and generate a magnetic flux, a stator and a rotor. The stator may include a stator flux-carrying element that provides magnetic flux paths for the stator, has a plurality of stator teeth and is magnetically permeable. The rotor may include a rotor flux-carrying element that provides magnetic flux paths for the rotor, has a plurality of rotor teeth and is magnetically permeable. The stator flux-carrying element and the rotor flux-carrying element together include at most three separable parts. In accordance with this aspect of the invention, a fully magnetically functioning stator and rotor for a motor phase may be provided with a relatively small number of parts, simplifying manufacture and assembly.

These and other aspects of the invention will be appreciated and/or obvious from the following description and the appended claims.

### BRIEF DESCRIPTION OF THE DRAWINGS

Aspects of the invention are described with reference to the following drawings in which like numerals reference like elements, and wherein:

FIG. 1 shows three basic components for a motor phase in one aspect of the invention;

FIG. 2 shows an assembled motor phase and a flux path for a single phase;

FIG. 3 shows a complete motor, composed of three phases and a shaft;

FIG. 4 shows an end view of the tooth alignment for three phases in the FIG. 3 embodiment;

FIG. 5 shows a basic control circuit for a single phase;

FIG. 6 shows switching waveforms and resulting current ripple for the circuit of FIG. 5;

FIG. 7 shows a control circuit allowing motor current recirculation;

FIG. 8 shows switching waveforms and resulting current ripple with recirculation;

FIG. 9 shows the relationship of torque to current for a motor in one illustrative embodiment;

FIG. 10 shows a linear motor embodiment in one aspect of the invention; and

FIG. 11 shows 6-step commutation timing and resulting torque ripple.

### DETAILED DESCRIPTION

Various aspects of the invention are described below with reference to illustrative embodiments. However, it should be understood that aspects of the invention are not limited to those embodiments described below, but instead may be used in any suitable system or arrangement. For example, an illustrative embodiment is described below in which motor phases include rotors positioned around a stator and arranged to rotate. It should be understood, however, that motor phases may include an internally positioned rotor that rotates within a stator. Also, although a coil with each motor phase is shown associated with the stator, the coil may be associated with the rotor. Other variations will be appreciated by those of skill in the art and are consistent with various aspect of the invention.

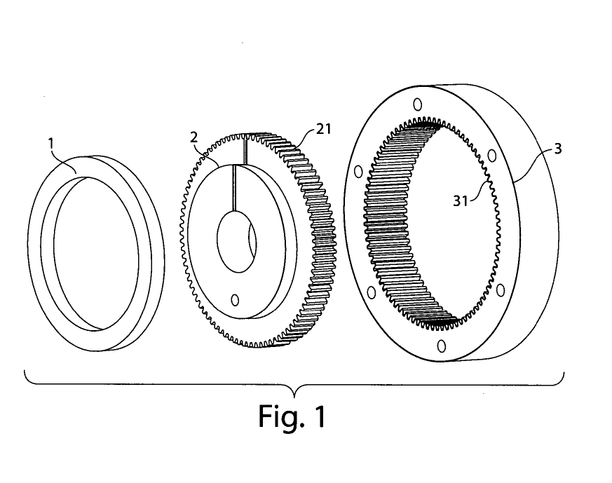

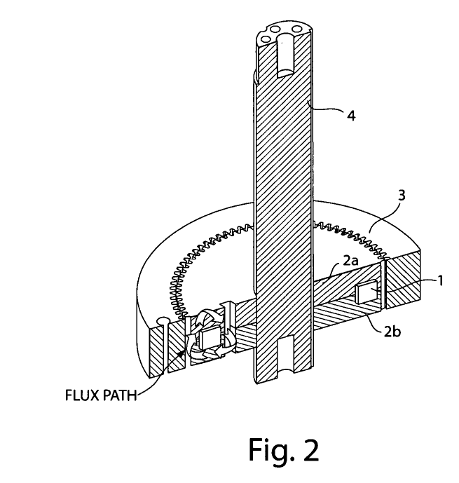

FIGS. 1 and 2 show an illustrative embodiment of a motor phase in accordance with the invention. The motor phase in this illustrative embodiment is composed of only 3 different parts, a coil 1, a stator 2 with two identical stator cups 2a,2b, and a rotor segment 3. (Only one stator cup 2a is shown in FIG. 1.) Although the coil 1, stator 2 and rotor 3 may each include as many parts as desired, in this embodiment, the coil, stator and rotor include a total of four parts. A single part in the rotor forms a rotor flux-carrying element, while two parts in the stator (the stator cups 2a,2b) form a stator flux-carrying element. The flux-carrying elements are the part(s) of the rotor and stator that carry the magnetic flux used to operate the motor phase. Although not present in this illustrative embodiment, the stator and/or rotor may include other parts, e.g., to provide mechanical support, electrical connections, etc., that do not function to carry a magnetic flux. The coil can be wound with automatic equipment and sandwiched between the pair of stator cups 2a,2b secured together by bolts, screws, adhesive, etc., as shown in FIG. 2. The stator cup and rotor segments each carry a plurality of teeth 21, 31 and can be fabricated from SMC powder to a net shape in just a few seconds on a press. The redundancy of parts and highly efficient fabrication techniques allow a very low-cost motor to be fabricated.

Unlike the motors described by Katzinger and Amreiz, the functional magnetic portions of rotor and stator (the flux carrying-elements) in one aspect of the invention do not include laminations, but are manufactured from solid, pressed SMC parts. By taking full advantage of allowing the magnetic flux to flow in three dimensions in the soft magnetic composite material, instead of two dimensions through laminations, this new design eliminates the steps of stamping the laminations, gluing or welding them together, final machining to correct for lamination stack misalignment and tolerance stack up, and the task of assembling many complex pieces with tight tolerances. Another advantage of this new design is that in this case, no additional space is needed for coil end turns, as would be the case with most conventional motors.

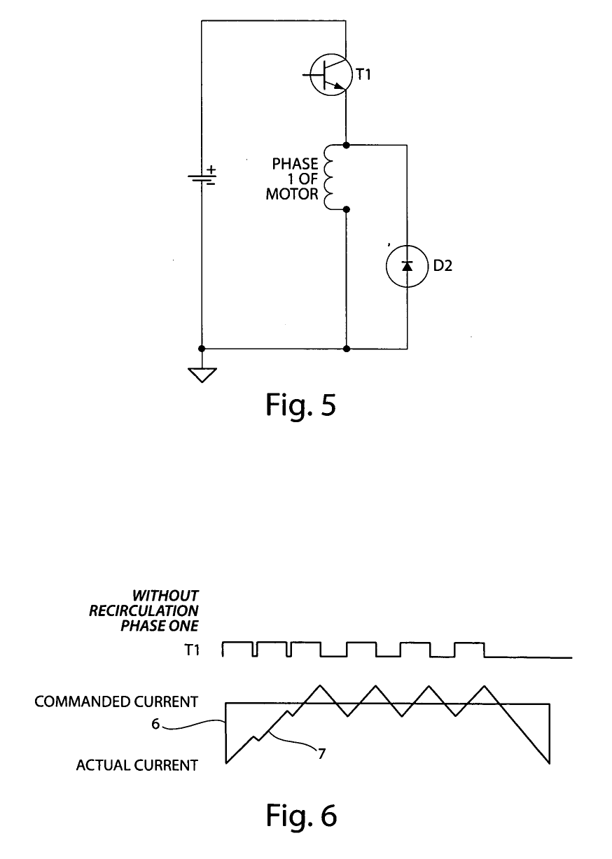

As shown in the assembled motor phase in FIG. 2, current flowing through the hoop coil 1 generates the magnetic flux for this motor. The magnetic flux travels radially inwards towards the center of the motor, up the stator 2, and travels back radially outwards through the second half of the stator 2, crosses the air gap between the stator and rotor, travels down the rotor 3, crosses the air gap a second time and returns to the stator 2. Magnetic flux passing through the teeth 21,31 and across the air gap creates a torque or alignment force that seeks to minimize the reluctance of the magnetic circuit by aligning the teeth 21,31 of a particular phase when current is passed through the coil. (“Aligned” rotor and stator teeth of a motor phase refers to the condition where the teeth are opposed to each other, as is the case between the tooth labeled 31 and the tooth labeled 21a in FIG. 4.) The torque of such a motor is proportional to the ratio of the unaligned teeth, or maximum reluctance, to the aligned teeth, or minimum reluctance. Thus, a magnetic flux generated by the coil will cause a torque to be exerted on the rotor relative to the stator so as to align the rotor and stator teeth, minimizing the reluctance of the system and urging the rotor to rotate relative to the stator. The teeth 21,31 are magnetically functioning elements; however it is possible to fill spaces between, or encapsulate, the teeth with a non-magnetic material, for improved strength, coil potting, or other reasons, such that there may be no visible teeth, without affecting the performance of the motor.

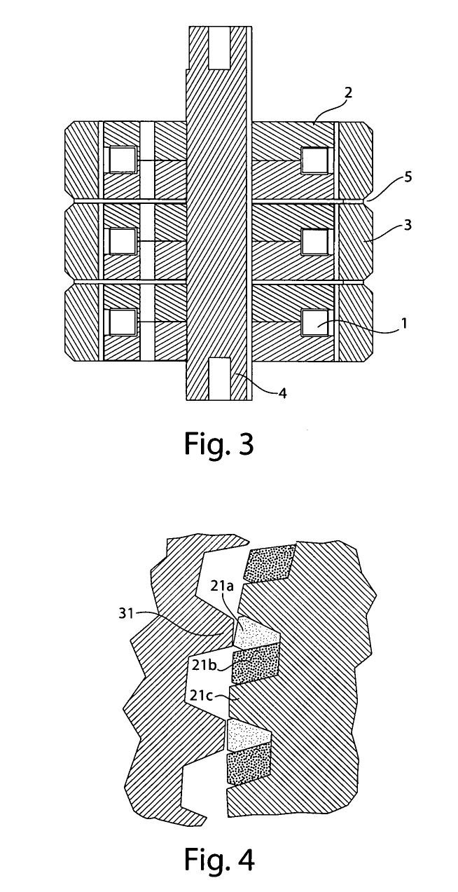

As shown in FIGS. 3 and 4, a multi-phase motor may be constructed by employing a plurality of phases in which the rotor and stator elements of the phases are secured together. In this embodiment, the rotors 3 of the three phases are secured together and rotate around the stators 2, which are fixed to each other and the shaft 4. The rotor and stator elements in the phases may be arranged relative to each other so that when the stator and rotor teeth of a selected phase are aligned (i.e., the rotors 3 are rotated so as to align the teeth of a rotor and stator of a selected phase), the stator and rotor teeth in each of the other motor phases are offset from each other. Generally, the stator and rotor teeth of the other motor phases may be offset from each other by an integer multiple of 1/N, where N is the number of phases included in the motor assembly. As will be understood by those of skill in the art, this offset allows rotation of the combined rotor elements to take place by sequentially energizing phases in the motor. For example, FIG. 4 shows an end view of the FIG. 3 embodiment in which the rotor and stator teeth of a selected phase are aligned, i.e., the stator teeth 21 a and the rotor teeth 31 of the selected phase are aligned. As can also be seen, the stator teeth 21b and 21c of the stators of the other phases are offset from the rotor teeth 31 in their respective rotors. (In this illustrative embodiment, the rotor teeth of the rotors in all three motor phases are axially aligned with each other for clarity and to aid in explanation. However, it should be understood that the teeth of the rotors in the different phases may or may not be aligned axially.) The stator teeth 21b are offset from the rotor teeth 31 of their respective rotor by about ⅓ of a pitch of the rotor and stator teeth. Similarly, the stator teeth 21c are offset from the rotor teeth of their respective rotor by about ⅔ of a pitch of the rotor and stator teeth. (The offset is ⅔ of a pitch of the teeth when considering a counter-clockwise offset. However, since this motor includes 3 phases, the offset of the teeth 21c is also about ⅓ of the tooth pitch in the clockwise direction.) The rotor and stator teeth in this example are offset by an integer multiple of ⅓ since the motor assembly in this embodiment includes three phases. Generally, however, the teeth of the phases are offset by a distance that is a multiple of 1/N of the tooth pitch, where N is the number of phases in the assembly.

It should be understood that other embodiments may have the rotor and/or stator teeth of the different phases arranged in any suitable way relative to each other. For example, the stator teeth of the phases may be axially aligned with each other (e.g., like the way the rotor teeth of the phases are axially aligned in FIG. 4) and the rotor teeth may be offset. Alternately, the teeth of both the stators and rotors of some or all phases may be axially misaligned or otherwise arranged as desired. Thus, there is no requirement that the stator or rotor teeth of the phases in a motor assembly be axially aligned like the rotor teeth in FIGS. 3 and 4. Rather, in accordance with one aspect of the invention, the rotor and stator teeth in phases need only be offset relative to each other when the rotor and stator teeth of a selected phase are aligned.

Stacking three motor phases on a central shaft 4 like that in FIG. 3 produces a complete three-phase motor. However, the motor need not be limited to three phases. Stacking N stator and rotor assemblies (phases) on a shaft produces a complete N phase motor. In addition, multiple “motors,” i.e., multiple motor assemblies each having a set of N phases each, can be placed on the same shaft, resulting in a motor that has two or more N phase assemblies. For example, a motor may include two or more of the motor assemblies shown in FIG. 3 using a common shaft 4. Although the rotor and stator teeth in each motor assembly may be arranged to provide the rotor/stator tooth offset described above, the rotor/stator teeth in one motor assembly need not necessarily be arranged in any particular way relative to the rotor/stator teeth in other motor assemblies. In the example where a motor includes two of the FIG. 3 motor assemblies, the teeth from a first stator in a first motor assembly may be axially aligned with teeth from a first stator in a second motor assembly, the teeth from a second stator in the first motor assembly may be axially aligned with teeth from a second stator in the second motor assembly, and so on. Alternately, the teeth in the first stator in the first motor assembly may be rotated, or offset, relative to the teeth of the first stator in the second motor assembly, and so on. Likewise for the rotor teeth. The rotor teeth of all of the phases in the motor assemblies may be axially aligned like that in FIG. 4, or offset relative to each other in any desired way. Also, the phases in each motor assembly need not be immediately adjacent each other or arranged in contiguous sets. For example, first stators in first and second motor assemblies may be adjacent each other, second stators from the first and second motor assemblies may be adjacent each other and adjacent the pair of first stators, and so on.

The stators and/or rotors of the motor phases may include alignment pins, serrations, indexing elements, or other features to help ensure proper alignment when motor phases are arranged together. For example, rotor elements 3 may have bolt holes arranged in them so that a common bolt used to secure rotors together also serves to align the teeth 31 of the rotors as desired. Similarly, the stators 2 may have bolt holes arranged so that when the stators are bolted together, the teeth 21 of the stators 2 are offset, as desired. Such features can help speed assembly and ensure proper arrangement.

In the above embodiment, the rotor segment 3 is pressed as a single SMC part and the stator is split into two identical pressed SMC parts 2 to allow the hoop coil to be separately wound and inserted between the sections of the stator. However, most of the same advantages could be achieved by alternate configurations such as a single piece stator on which the coil is wound, a three piece stator that separates a smaller diameter coil disk from two outer tooth disks, and/or separating the tooth section of the stator or rotor into two or more sections, which may facilitate the manufacturing of larger diameter motors.

To understand a further improvement in this new design, it should be noted that when a motor is at stall or at low speeds, essentially all of the motor losses are due to resistance in the windings and to hysteresis losses generated by the pulse-width-modulated (PWM) switching of the current by the power amplifier, as motor commutation switching frequencies are low. For many direct-drive applications stall and low-speed performance are of primary interest. Therefore, minimizing resistance and PWM losses may be extremely important in these applications.

To address this issue, a motor in accordance with the invention may employ a hoop coil that is wound from flat copper foil, instead of round wire, eliminating or reducing the air spaces associated with winding with round wire and thereby increasing the fill factor to at least 60%, and to as much as 90% or more, as opposed to the fill factor of 55% disclosed by Amreiz. This fill factor is largely determined by the thickness of insulation necessary to coat the copper foil, as there are little or no voids due to geometry or winding constraints. The higher fill factor of this hoop coil reduces the motor resistance for a given volume, by the effective increase in fill factor, or about 35%. This in turn may reduce resistance-heating loss in the motor by 35%.

To further improve the thermal properties of this motor, recently introduced third generation SMC material can be used. This new material has much higher permeability than older second generation SMC material as well as lower AC hysteresis losses. This higher permeability, lower hysteresis loss, and the associated lower heat generation may be critical for many high torque applications.

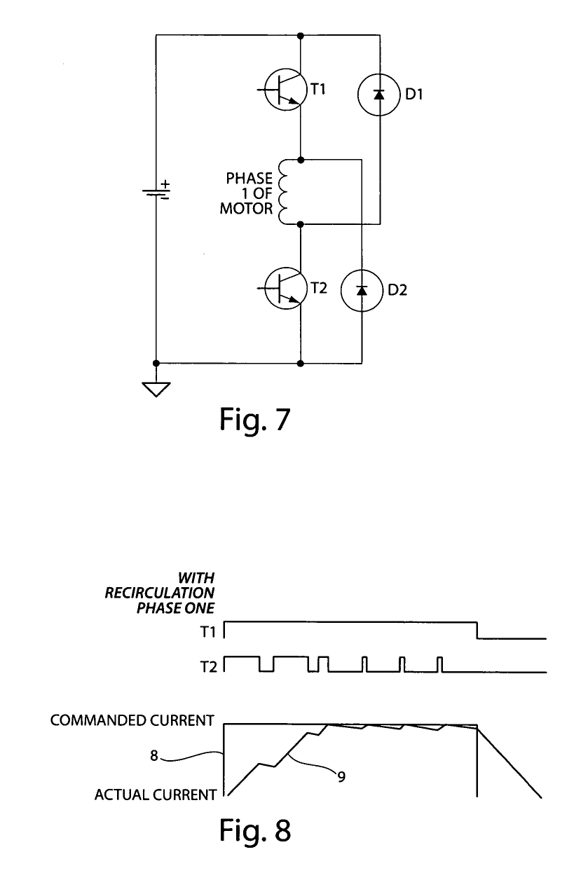

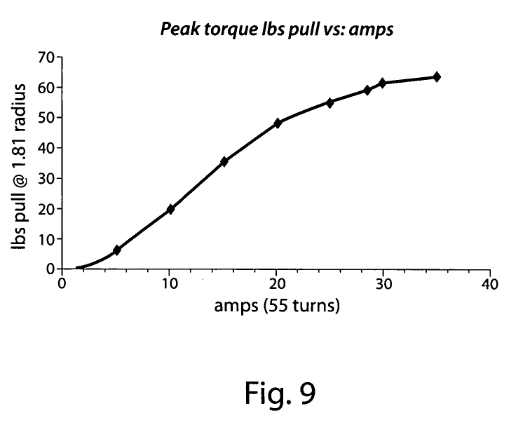

A common circuit for controlling one phase of a switched reluctance motor is shown in FIG. 5, where the current in the motor phase is controlled by a pulse-width modulated signal at the gate of a transistor T1. The gate control signal for T1 is shown in FIG. 6, along with the desired current 6 and the resulting actual current 7. The current slews up and down at a rate determined by di/dt=V/L, where i is the current in the coil, V is the voltage applied, and L is the coil inductance. This results in a large current ripple from the PWM cycle, even if the current command is constant (see FIG. 6). This large current ripple results in large magnetic hysteresis losses from the PWM cycle, and thus in turn generates unwanted heat, roughness in the motion resulting in noise, and places a large current ripple demand on the power supply.

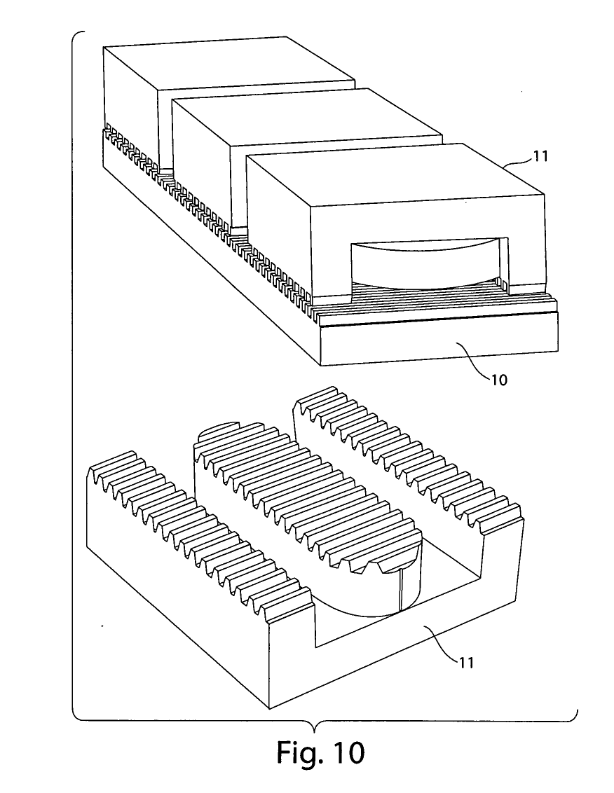

While a motor in accordance with the invention could be controlled by the circuit of FIG. 5, FIG. 7 shows an alternate controller circuit having an amplifier that greatly reduces the losses due to PWM switching of current and may be used as a further performance enhancement. This amplifier uses two power transistors in series to switch each phase of the motor. The collector of the upper transistor T1 is tied to high voltage. The emitter of the upper transistor is connected to one end of a motor phase. The other end of the motor phase is connected to the collector of the lower transistor. The emitter of the lower transistor T2 is connected to ground. A flyback diode D1 is connected from the collector of the lower transistor to high voltage. A second flyback diode D2 is connected from ground to the emitter of the upper transistor.

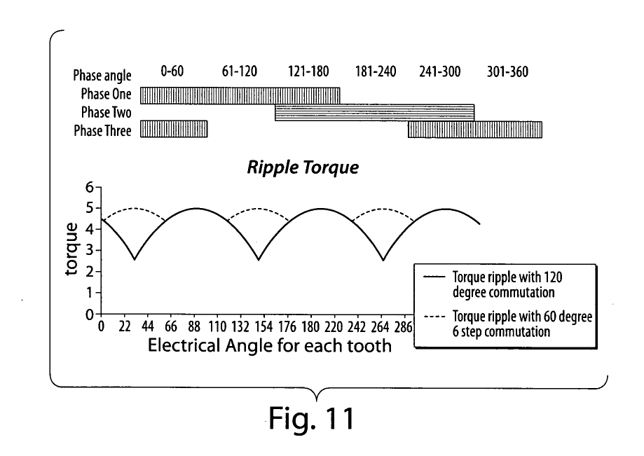

This configuration is then switched, such that to turn on current in a phase, both transistors are turned on. However to control current in the phase during the commutation period, only the lower transistor is switched on and off with a pulse-width-modulated frequency. The flyback diode D1 allows the energy stored in the magnetic field to generate current, which flows back through the diode to the high voltage terminal and back through the upper transistor and hence through the motor phase. This is referred to as “recirculation” in the literature. As shown in FIG. 8, the ripple current 9 is greatly reduced, bringing it much closer to the commanded current 8 in the motor during the PWM cycle, hence greatly reducing heating due to PWM hysteresis loss. For example, in a prototype motor, current ripple was reduced from 4.8 Amps to 0.2 Amps at a PWM frequency of 20 KHz.

The potentially large number of effective poles in a motor in accordance with some aspects of the invention requires commutating the motor many times for each revolution of the motor. For example, a prototype motor with an arrangement like that in FIG. 3 has 72 rotor and stator teeth in each phase. Since three phases must be energized in sequence to rotate the rotor one tooth pitch, the motor must be commutated 216 times per revolution. This is a much higher rate than say, an 8-pole (4 pole pair) permanent magnet motor, which would be commutated 4 times per revolution. As a result, the angle during which commutation must take place is much smaller than with a permanent magnet motor. The speed of this motor will be limited by how quickly the current can rise during commutation. The current rise rate per unit time (di/dt), is equal to the voltage across the motor divided by the motor inductance. The current cannot rise instantaneously, and as the motor rotates faster, a point is reached at which the current does not have enough time during a commutation cycle to rise to its maximum value. This limits the speed and torque of the motor.

Current rise time can be extended by turning the current on sooner, while the current in the previous phase is still turned on, rather than waiting until the nominal 120 electrical degree commutation point and turning off one phase and turning on the next phase. Turning on two phases at the same time can generate two benefits.

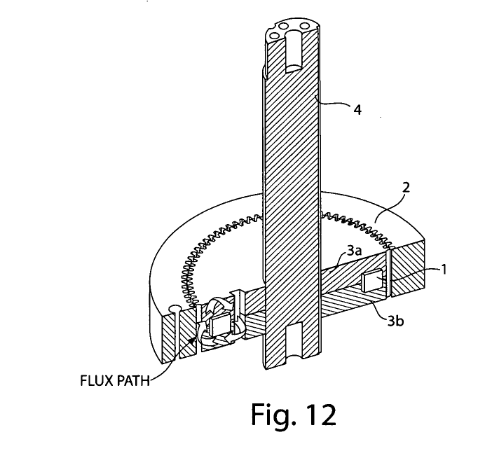

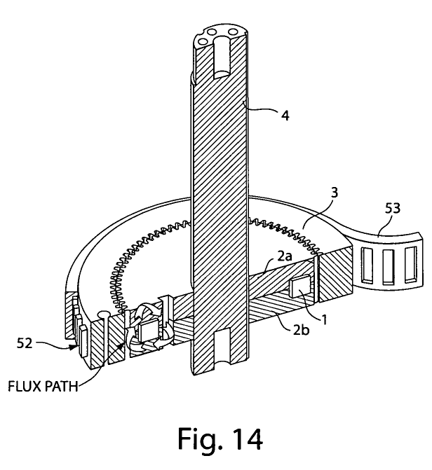

For constant current, the motor torque will decrease from its peak value at 60 degrees electrical phase angle, in a semi-sinusoidal manner to 50% of peak at 120 degrees electrical phase angle. By turning on the current in the next phase at 60 degrees electrical phase angle, it is possible to add torque such that only a 13% torque ripple is generated. Torque ripple is the fluctuation in actual motor torque compared to constant torque when a constant magnitude current is applied and switched from one phase to another as the motor rotates. This is commonly done in 3 phase motors and is referred to as “6 step commutation”, in which one of 3 phases is switched on or off every 60 degrees of electrical phase angle. (The electrical phase angle corresponds to the position of rotor teeth relative to corresponding stator teeth. Movement of a rotor by 360 degrees electrical phase angle corresponds to the movement of the rotor by one tooth pitch relative to the stator. In the case of a 72 tooth rotor, movement over 360 degrees electrical phase angle corresponds to 1/72 of a complete rotation of the rotor. Thus, at 0 degrees electrical phase angle, the rotor and stator teeth of a motor phase are aligned, at 60 degrees electrical phase angle the rotor is rotated by ⅙ of the tooth pitch relative to the stator teeth, at 180 degrees electrical phase angle the rotor is rotated by ½ the tooth pitch relative to the stator teeth, and so on.) In addition, the remaining 13% torque ripple can be cancelled by modifying the nominal current command as a function of phase angle (see FIG. 11). Aspects of the invention greatly facilitate this approach, as each phase is magnetically separated from the other phases. In most permanent magnet and most switched reluctance motors, magnetic flux from different phases flows through a shared back iron structure, such that turning on an adjacent phase causes flux coupling and non-linear behavior of torque with respect to current, making ripple compensation at higher flux densities and high speeds almost impossible. At low current, switched reluctance motors generate magnetic flux which is proportional to the square of the current; at medium currents, flux is linearly proportional to current; and at high currents, the flux rise rate falls off to zero as the iron saturates (see FIG. 9). As a result of all this, sharing flux from multiple phases in the same back iron creates problems as the flux resulting from adding current in one phase may depend on the flux in the back iron from adjacent phases, especially at higher currents where the back iron begins to saturate magnetically.

It is also possible to compensate for the current rise lag generated by the motor inductance by turning the phases on and off earlier as motor speed increases. This is known as “phase advance” and is also greatly facilitated by magnetically separated phases, as the flux in the back iron is not influenced by flux from adjacent phases, allowing the magnitude of the flux to be influenced only by the current and inductance in a single phase.

For high speeds where high torque is desired, it is sometimes desirable not to reduce the current all the way to zero in what would be a non-commutated phase at a lower speed. This is because the slope of the curve relating flux (torque) to current (the BH curve, also know as the “permeability” of the motor) is steeper at medium currents than at low currents for switched reluctance motors as mentioned above. In FIG. 9, raising the current from 0 to 3 amps results in the pull generated by the motor rising by 3 lbs, or 1.0 lb/A. However, from 5 to 10 A the pull rises by 12 lbs for 5 A, or 2.4 lbs per amp. As a result at high speeds, when total current rise is limited by small commutation times and motor inductance, more torque can be generated by switching the current up and down from a “floor” or minimum value, where the BH curve becomes linear. The negative torque generated by the floor current in an out of phase winding, is more than offset by the proportionally higher torque generated by switching higher on the BH curve. In this example, switching between 3 and 10 amps generates 17 lbs of positive force, offset by 3 lbs of negative force for the 3-amp floor, giving a net force of 14 lbs. Switching between zero and 7 amps generates about 12 lbs of force. This effect is even more pronounced in higher permeability motors, as the medium current slope is much steeper.

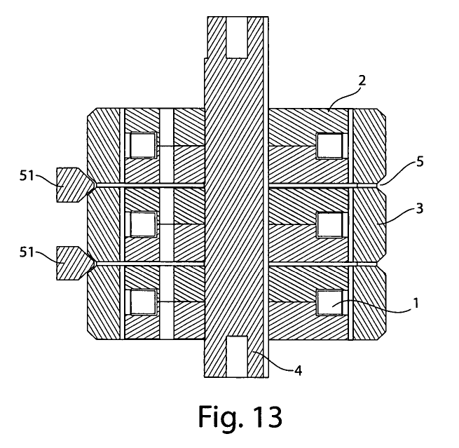

While this description of illustrative embodiments has focused on a rotary version of a new direct-drive motor made using SMC material, all of the concepts apply as well to a linear motor. For example, as shown in FIG. 10, the stator 10 and rotor 11 are unfolded into flat pieces with a flat, linear tooth pattern. A hoop coil 12 embedded in the stator can again be used to generate a magnetic flux between the stator and rotor. By positioning three such linear single-phase assemblies side-by-side or sequentially along a linear guide, a 3 or more phase, direct-drive linear motor can be produced using the same techniques as described above.

Also, while the described embodiment has the stator mounted on the inside of the rotor, the design can be easily be turned inside-out with the stator and hoop coil mounted outside of the rotor. It is also possible to place the coil inside the rotor, instead of the stator, although this may present complications in connecting the coil electrically.

Also, the mechanical design of this motor allows the low-cost incorporation of power transmission features. One such power transmission feature is a set of V-grooves 5 created by chamfering the outside edges of the cylindrical rotor segments 3, as shown in FIG. 3. These V grooves 5 can be used to receive and guide power transmission V-belts, and can be molded directly into the rotor segment for no additional cost. A second possible power transmission feature is the creation of timing belt pulley teeth, also molded directly into the rotor outer surface, eliminating subsequent machining normally required to create such a feature.

While aspects of the invention have been described with reference to various illustrative embodiments, the invention is not limited to the embodiments described. Thus, it is evident that many alternatives, modifications, and variations of the embodiments described will be apparent to those skilled in the art. Accordingly, embodiments of the invention as set forth herein are intended to be illustrative, not limiting. Various changes may be made without departing from the invention.

1. A variable reluctance motor comprising: at least N motor phases where N is equal to at least three, each phase including:
a coil adapted to carry an electrical current and generate a magnetic flux;
a stator including a stator flux-carrying element that provides the magnetic flux paths for the stator, the stator flux-carrying element having a plurality of stator teeth and being made entirely of SMC; and
a rotor that is magnet-free and including a rotor flux-carrying element that provides the magnetic flux paths for the rotor, the rotor flux-carrying element having a plurality of rotor teeth and being made entirely of SMC;
wherein the stators and rotors of the N motor phases are arranged relative to each other so that when the stator and rotor teeth of a selected phase are aligned, the stator and rotor teeth in each of the other motor phases are offset from each other.

2. The motor of claim 1, further comprising:
a shaft to which each of the stators in the N motor phases are secured.

3. The motor of claim 2, wherein the coil in each motor phase is a hoop coil.

4. The motor of claim 3, wherein the coil is fixed relative to the stator in each motor phase.

5. The motor of claim 4, wherein each of the stator flux-carrying elements includes two identical portions that are mated together and form a channel for the coil.

6. The motor of claim 1, wherein each of the stator flux-carrying elements includes two identical portions that are mated together and form a channel for the coil.

7. The motor of claim 1, wherein each of the rotor flux-carrying elements includes two identical portions that are mated together and form a channel for the coil.

8. The motor of claim 1, wherein the rotor of each motor phase is movable in a rotary fashion relative to the stator of a corresponding motor phase.

9. The motor of claim 1, wherein the rotor of each motor phase is movable in a linear fashion relative to the stator of a corresponding motor phase.

10. The motor of claim 1, wherein the stator flux-carrying element and the rotor flux-carrying element for each motor phase together include at most three separable parts.

11. The motor of claim 1, wherein the N motor phases together constitute an N phase motor, and the variable reluctance motor includes a plurality of N phase motors.

12. The motor of claim 1, wherein each motor phase has a coil with a fill factor of at least 60%.

13. The motor of claim 1, wherein the coil is a hoop coil formed from a flat foil.

14. The motor of claim 1, further comprising a controller that includes a pair of transistors connected in series with the coil and a pair of flyback diodes each connected between a corresponding transistor and the coil.

15. The motor of claim 14, wherein the controller uses a recirculation switch timing to control the transitors.

16. The motor of claim 1, wherein the current in coils for first and second motor phases is simultaneously commutated over at least 60 degrees electrical phase angle of rotation, where 360 degrees electrical phase angle represents one tooth pitch, and wherein current is ramped up in the second motor phase while current is ramped down in the first motor phase such that both currents contribute to drive the motor in a same direction and to reduce torque ripple.

17. The motor of claim 1, wherein a nominal current command in one or more of the N motor phases is modified as a function of phase angle to reduce torque ripple.

18. The motor of claim 1, wherein the timing of turning on and off a current provided to coils in the motor phases is adjusted as motor speed increases.

19. The motor of claim 1, wherein current provided to the coils in the motor phases is maintained above zero for motor speeds above a desired threshold.

20. The motor of claim 1, wherein each rotor has an approximately cylindrical outer shape and is arranged to rotate around a corresponding stator, each rotor including a chamfered edge at at least one end that mates with another rotor, the mating chamfered edges of the rotors forming a groove to receive at least a portion of a drive belt.

21. The motor of claim 1, wherein at least one rotor has an approximately cylindrical outer shape with an outer surface that includes teeth for cooperation with a timing belt.

22. The motor of claim 1, wherein when the stator and rotor teeth of the selected phase are aligned, the stator and rotor teeth in each of the other motor phases are offset from each other by an integer multiple of 1/N of a pitch of the stator or rotor teeth.

23. The motor of claim 22, wherein the integer multiple of 1/N is not equal to 1.

24. The motor of claim 1, wherein the stator teeth of each phase are offset from the stator teeth of the other phases by an integer multiple of 1/N of a pitch of the stator teeth, and the rotor teeth of the phases are axially aligned with respect to each other.

25. The motor of claim 1, wherein the rotor teeth of each phase are offset from the rotor teeth of the other phases by an integer multiple of 1/N of a pitch of the rotor teeth, and the stator teeth of the phases are axially aligned with respect to each other.

26. A variable reluctance motor comprising N motor phases, each phase including:
a coil adapted to carry an electrical current and generate a magnetic flux;
a stator including a stator flux-carrying element that provides a magnetic flux path for the stator, the stator flux-carrying element having a plurality of stator teeth and being magnetically permeable; and
a rotor that is magnet-free and including a rotor flux-carrying element that provides a magnetic flux path for the rotor, the rotor flux-carrying element having a plurality of rotor teeth and being magnetically permeable;
wherein the coil has a fill factor of at least 60%.

27. The motor of claim 26, wherein the coil in each motor phase is a hoop coil.

28. The motor of claim 26, wherein the coil is fixed relative to the stator in each motor phase.

29. The motor of claim 26, wherein the stator flux-carrying element includes two identical portions that are mated together and form a channel for the coil.

30. The motor of claim 26, wherein each of the rotor flux-carrying elements includes two identical portions that are mated together and form a channel for the coil.

31. The motor of claim 26, wherein the rotor of each motor phase is movable in a rotary fashion relative to the stator of a corresponding motor phase.

32. The motor of claim 26, comprising a plurality of motor phases.

33. The motor of claim 26, wherein the coil is a hoop coil formed from a flat foil.

34. The motor of claim 26, comprising a plurality of motor phases, and wherein when the stator and rotor teeth of a selected phase are aligned, the stator and rotor teeth in each of the other motor phases are offset from each other by an integer multiple of 1/N of a pitch of the stator or rotor teeth.

35. The motor of claim 34, wherein the integer multiple of 1/N is not equal to 1.

36. A variable reluctance motor comprising N motor phases, each phase including:
a coil adapted to carry an electrical current and generate a magnetic flux;
a stator including a stator flux-carrying element that provides a magnetic flux path for the stator, the stator flux-carrying element having a plurality of stator teeth and being magnetically permeable; and
a rotor that is magnet-free and including a rotor flux-carrying element that provides a magnetic flux path for the rotor, the rotor flux-carrying element having a plurality of rotor teeth and being magnetically permeable;
wherein the stator flux-carrying element and the rotor flux-carrying element together include at most three separable parts.

37. The motor of claim 36, wherein the stator flux-carrying element includes two separable parts and the rotor flux-carrying element includes a single part.
